(19) United States
(12) Patent Application Publication
(10) Pub. No.: US 2003/0217018 A1
(43) Pub. Date: Nov. 20, 2003

(54) System and method for conducting a shipping transaction

(76) Inventors: Jason J. Groff, Woodstock, GA (US); John Olival, Oxford, MA (US)

Correspondence Address: J. Michael Martinez de Andino, Esq., HUNTON & WILLIAMS, Riverfront Plaza, East Tower, 951 East Byrd Street, Richmond, VA, 23219-4074, US

(21) Appl. No.: 10/150,162

(22) Filed: May 17, 2002

(51) Int. Cl. G06F 17/60

(52) U.S. Cl. 705/404; 705/406

(57) ABSTRACT

A shipping transaction system comprises a plurality of ordering stations, each ordering station having a user interface with a display device and at least one input device. The system further comprises a data processing system in communication with the display device and the at least one input device. The data processing system is adapted for selective connection to a first network, for displaying information using the graphical display device, for receiving information from the input device, and for selective communication with at least one shipper ordering and tracking system via the first network. A first portion of the data processing system is adapted for processing shipping preference information and item information received from a customer during a shipping transaction. The first portion of the data processing system is also adapted for constructing a menu of shipping product options, for displaying the menu to the customer using the display device and for receiving a shipping product selection from the customer for shipping an item. A second portion of the data processing system is adapted for use in communicating transaction information to any of the at least one shipper ordering and tracking system and for use in receiving product information and tracking information from any of the at least one shipper ordering and tracking system.

### BACKGROUND OF THE INVENTION

The present invention relates generally to package shipping services and more particularly to methods and systems for providing self service shipping products to shipping service customers.

In recent years, businesses and individuals have come to rely heavily on commercial delivery services for a variety of shipping services. As a result, there has been significant competition between commercial shippers and pressure to provide faster service and lower prices. Shippers have also fought to make their services more convenient by providing 24-hour drop boxes in addition to door-to-door service. Unattended drop boxes, however, cannot be used when contemporaneous payment is required. Moreover, drop boxes cannot provide choices to a customer who is uncertain as to the shipping product desired. Shippers may provide a variety of shipping products that vary in cost as a function of the destination, mode of transport, desired arrival time and physical characteristics of the package being shipped. Drop boxes can only be used when the customer knows the desired shipping product and has previously established payment arrangements with the shipper. Even if the customer knows the desired product and has arranged for payment, the final cost of the product cannot be determined unless a particular envelope is used or certain physical characteristics of the package (e.g., linear dimensions and weight) are known.

Another characteristic of drop boxes and other current shipping facilities is that they are generally owned or established by a particular shipper. Consequently, such facilities provide only the products of that shipper. Customers are thus forced to obtain information from multiple sources or facilities in order to make an informed purchase of a shipping product.

### SUMMARY OF THE INVENTION

The present invention provides systems and methods for conducting shipping transactions wherein customers are provided instant access to information on a variety of shipping products provided by one or more shippers.

One aspect of the invention provides a system for conducting a shipping transaction that comprises a plurality of ordering stations, each ordering station having a user interface with a display device and at least one input device. The system further comprises a data processing system in communication with the display device and the at least one input device. The data processing system is adapted for selective connection to a first network, for displaying information using the graphical display device, for receiving information from the input device, and for selective communication with at least one shipper ordering and tracking system via the first network. A first portion of the data processing system is adapted for processing shipping preference information and item information received from a customer during a shipping transaction. The first portion of the data processing system is also adapted for constructing a menu of shipping product options, for displaying the menu to the customer using the display device and for receiving a shipping product selection from the customer for shipping an item. A second portion of the data processing system is adapted for use in communicating transaction information to any of the at least one shipper ordering and tracking system and for use in receiving product information and tracking information from any of the at least one shipper ordering and tracking system.

Another aspect of the invention provides a method of conducting a shipping transaction that uses a shipping transaction system having a data processing system in selective communication with at least one shipper purchasing and tracking system. The method comprises providing an ordering station having a user interface with a graphic display device and at least one input device. The user interface is in communication with the data processing system. The method further comprises receiving shipment information into the data processing system. The shipment information includes customer shipping preferences and characteristics of an item to be shipped. At least a portion of the shipment information received by the data processing system is entered into the shipping transaction system by a customer using the at least one input device. The method also comprises receiving shipping product information into the data processing system from the at least one shipper purchasing and tracking system. A set of shipping product options is determined using the shipment information and the shipping product information. The set of shipping product options is then displayed to the customer using the graphic display device. A shipping product selection is received from the customer using the at least one input device. The method further comprises receiving the item to be shipped into a storage area for later pick-up.

Other objects and advantages of the invention will be apparent to one of ordinary skill in the art upon reviewing the detailed description of the invention.

### BRIEF DESCRIPTION OF THE DRAWINGS

FIG. 1 is a schematic representation of a shipping transaction system according to an embodiment of the invention;

FIG. 2 is a schematic representation of a data processor of a shipping transaction system according to an embodiment of the invention;

FIG. 3 is a perspective view of an ordering station of a shipping transaction system according to an embodiment of the invention;

FIG. 4 is a flow diagram of a shipping transaction method according to an aspect of the invention;

FIG. 5 is a schematic representation of a shipping transaction system according to an embodiment of the invention; and

FIG. 6 is a schematic representation of a transaction server and a shipper interface server of a shipping transaction system according to an embodiment of the invention.

### DETAILED DESCRIPTION OF THE INVENTION

The present invention provides a package shipping system having a plurality of networked customer ordering stations. These ordering stations are able to receive information from and transmit information to one or more shipping service providers (“shippers”) or a central processing facility to facilitate self-service package shipping transactions for customers using the ordering stations. Based on information provided by the customer and on measurable package characteristics, each ordering station can instantaneously provide the customer with cost and other information for each shipper, thus allowing the customer to choose the shipper and product that best serves his needs. In some embodiments, an unattended ordering station may be configured to accept payment or verify customer account information. Once a product selection has been made and payment verified, transaction and package information is communicated to the selected shipper's tracking system and the ordering station prints a shipping label to be applied to the package. In some embodiments, the ordering station is semi-attended. In such embodiments, the transaction is completed when payment is made to an attendant or cashier, who receives the printed label and applies it to the package. The package is then placed in a storage area to await pickup by a representative of the shipper.

As used herein, the term “shipping product” means a service offered by a shipper wherein the shipper takes possession of an item and delivers it to a particular destination, the cost of the service being dependent on the characteristics and limitations of the service and the characteristics of the item.

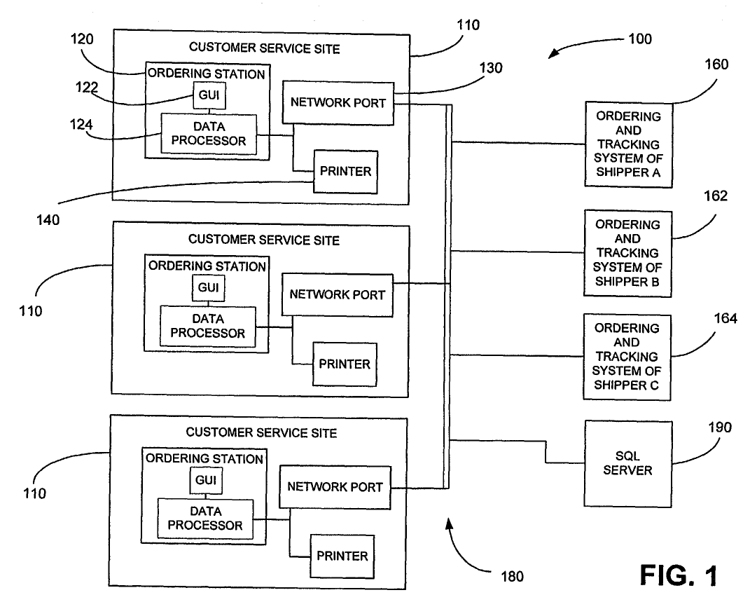

Embodiments of the invention will now be discussed in more detail. FIG. 1 is a schematic representation of a shipping system 100 according to the invention. The shipping system 100 includes a plurality of ordering stations 120, each located at a different customer service site 110. Possible customer service sites 110 may include, for example, convenience stores, mailing service outlets and shopping malls. The shipping system 100 includes a data processing system that includes a data processor 124 and a graphical user interface (GUI) 122 at each ordering station 120. The GUI 122 preferably includes means for displaying a series of graphical images that assist in conducting a shipping transaction with a customer. These images are configured to lead the customer through a step-by-step process for purchasing a shipping product. The GUI 122 includes one or more input devices such as a touch-screen or keyboard for use by the customer in providing information to the shipping system 100. The ordering station 120 may also include a scale for weighing packages and/or an arrangement for measuring package dimensions. The scale and measuring arrangement may be configured to automatically provide weight and size information to the data processor 124. Alternatively, the scale and measuring arrangement may be configured to provide information to the customer who can then enter the information into the data processor 124 using the input device of the GUI 122.

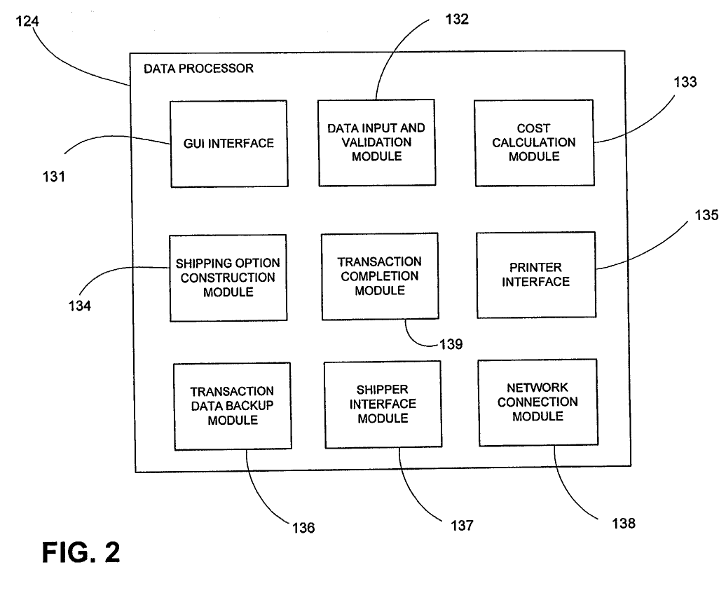

Each data processor 124 is configured and programmed for conducting shipping transactions and for communicating with the ordering and tracking systems 160, 162, 164 of one or more shippers A, B, C. With reference to the schematic representation in FIG. 2, the data processor 124 may include a GUI interface 131, a data input and validation module 132, a cost calculation module 133, a shipping option construction module 134, a printer interface 135, a transaction data backup module 136, a shipper interface module 137, a network connection module 138 and a transaction completion module 139.

The GUI interface module 131 is used to send output to and receive input from the GUI 122. The data input and validation module 132 is configured and programmed to transmit prompts to the customer for the information required for conducting a shipping transaction. This information may include desired shipping destination and arrival time, package characteristics, desired price range and individual customer information. The prompts are displayed to the customer using the GUI 122. The data input and validation module 132 is further configured to receive responses to these prompts entered by the customer using the GUI 122.

The data input and validation module 132 is adapted to review the various customer data entries to assure their validity. Among other things, the data input and validation module 132 may be used to assure that valid zip code, telephone, street address and e-mail address information is entered. The data input and validation module 132 may also be used to assess whether all required data fields are populated and all required selections made. Other customer information may also be verified.

The cost calculation module 133 uses shipping product and cost information from the shippers along with information provided by the customer to determine the cost of various shipping options. The shipping option construction module 134 then uses the calculated cost information to construct a menu of shipping product options and associated costs for display to the customer using the GUI 122. The assembled menu may be limited to only those options meeting the criteria entered by the customer. Alternatively, the menu may include other options that are close to meeting such criteria.

In an illustrative embodiment, the cost calculation module 133 includes software for calculating cost based on the shipping origin and destination zip codes. This software may use look-up tables or formulas provided by the various shippers to determine costs for various options. In an exemplary cost determination scenario, a shipper's cost structure may be based on discrete distance ranges (zones). Different cost formulae or tables are used for each zone. The zone for a given transaction may be determined by the cost calculation module 133 using longitude and latitude values for the origin and destination zip codes. The formulae or tables for that zone may then be used to establish rates for the given package size and weight and various service options that meet the customer's shipping criteria. Additional charges may be added for such special services as Saturday delivery, signature delivery, rural delivery, etc. The cost calculation module 133 may also apply a predetermined premium to the costs calculated from the shippers' cost information.

Upon display of the shipping option menu, the shipping option construction module 133 prompts the customer to make a selection from displayed options. The transaction completion module 139 is configured and programmed to receive an option selection from the GUI 122. The transaction completion module 139 assembles a set of transaction information which includes customer information, information relating to the item to be shipped and information for the selected shipping product.

In some embodiments, the transaction completion module 139 may also be adapted for requesting payment from the customer. In such embodiments, payment is preferably made by providing credit or debit account information to the data processor 124 using the GUI 122. The transaction completion module 139 may be adapted for validating the payment information provided by the customer. In addition or in the alternative, the ordering station 120 may be equipped with cash accepting devices such as coin or bill receivers. In such embodiments, the transaction completion module 139 may be configured to verify that the proper amount has been deposited before proceeding with a transaction.

The transaction completion module 139 provides transaction information to the shipper interface module 137. The shipper interface module 137 includes interface software to complete shipping orders with the purchase and tracking software of the shippers. The interface software is specifically adapted to be compatible with the shippers' systems and may be provided by the shippers themselves. For a given transaction, the shipper interface module 137 assures that all information required by the selected shipper is present and assembled in the correct format for receipt by the shipper's ordering and tracking system.

The shipper interface module 137 communicates transaction information to the purchasing and tracking system of the shipper selected by the customer. In some embodiments, the shipper interface module 137 may receive in return, information for use by the printer interface 135 in printing a shipping label for the item to be shipped or for providing to the customer for his use in tracking the package. The transaction information provided by the shipper interface module 137 may include the selected shipper, the type of shipping product selected (transportation mode, destination, arrival time, etc.), size and weight of the item, location of the ordering station and customer information. Information returned by the shipper to the shipper interface module 137 may vary depending on the shipper.

The data processor 124 uses a network port 130 to selectively connect the data processor 124 to the ordering and tracking systems 160, 162, 164 of the shippers A, B, C via a network 180. The network 180 may be any distributed network, such as a local area network (LAN), a wide area network (WAN), Internet, Ethernet, etc. The network may include wired and/or wireless components to enable access to and communication among the various system components. In a preferred embodiment, the network port 130 includes an arrangement for satellite access to the Internet, through which the data processor 124 can access the shippers' systems 160, 162, 164.

A network connection module 138 in the data processor 124 is configured to establish a connection to the network and the shippers' ordering and tracking systems. This connection may be used to access current price and ordering information from a given shipper or to transmit transaction information to the shipper. Price information is preferably obtained from the shippers at regular predetermined intervals. Alternatively, price information may be updated at the time of a transaction.

The network connection module 138 may also be configured to establish a connection to an SQL server 190 via the network 180. This allows the network connection module 138 to transmit transaction information to the SQL server 190 where it can be stored. The SQL server 190 may be configured to track and store transaction information from all of the ordering stations 120. Transaction information stored by the SQL server 190 may be used to generate manifest information, customer invoices and billing information.

The data processor 124 may include a transaction data backup module 136. The data backup module 136 may be used to temporarily store information provided by a customer during a transaction or to store the transaction data for a completed transaction. The data backup module 136 may be adapted to retain transaction information from one or more transactions for subsequent transmission to a shipper or to the SQL server 190. The data backup module 136 may also be used to store manifest information for subsequent printout by shipper pickup personnel.

Each customer service site 110 may have one or more printers 140 in communication with the printer interface of the data processor 124 in the associated ordering station 120. The printer or printers 140 may be used for printing shipping labels, receipts and manifest information. In some embodiments, a printer 140 may be incorporated into the ordering station 120 itself. In such embodiments, the printer 140 can be used to provide a shipping label directly to a customer upon verification of payment or account information. In other embodiments, such as those located inside a retail outlet, a printer 140 may be physically separated from the ordering station 120 so as to be accessible to an attendant or cashier. In these embodiments, the printer 140 can be used to print labels for application by the attendant or for the attendant to relay to the customer upon payment.

At least one printer 140 at each customer service site 110 is preferably accessible by shipping service pickup personnel for use in printing manifest information. This allows pickup personnel on regular schedules to print a list of the items (if any) to be picked up from that customer service site 110. This list can then be used to assure that all such items are indeed taken into the shipper's possession.

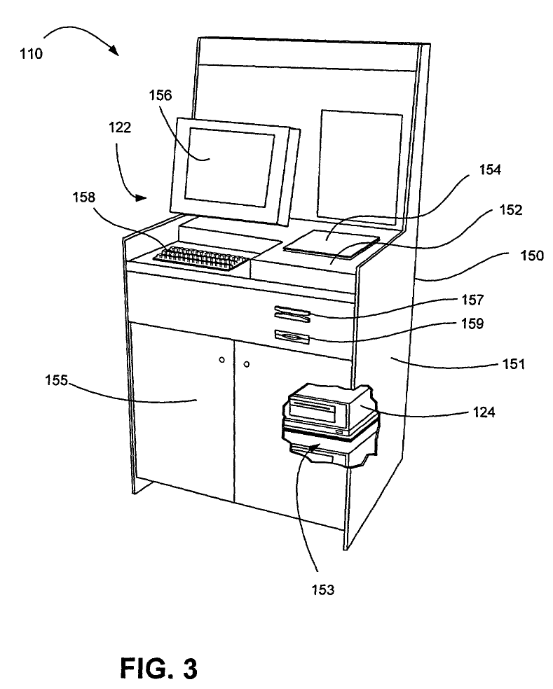

An exemplary configuration for an ordering station 120 is shown in FIG. 3. It will be understood that the ordering station configuration of FIG. 2 is illustrative only and that many other configurations may be used that fall within the scope and spirit of the present invention. The exemplary ordering station 120 is configured as a kiosk 150 having a counter 152 on which a scale 154 and a GUI 122 are disposed. As illustrated in FIG. 3, the GUI 122 includes both a touch screen 156 and a keyboard 158 for use by the customer in providing information to the data processor 124. Other preferred embodiments, however, do not include a keyboard. In such embodiments, all customer-supplied information may be entered using the touch screen 156. The kiosk 150 has a cabinet portion 151 defining an interior space 153 in which the data processor 124 or a portion of the data processor 124 may be disposed. Equipment within the interior space 153 is accessible through the cabinet doors 155 on the front of the kiosk 150. In this exemplary embodiment, a printer 140 may be disposed within the interior space 153. Material such as labels or receipts may be received from the printer 140 through a printer slot 159 in the front wall of the cabinet portion 151. The kiosk may also include a magnetic card reader 157 in communication with the data processor 124. The magnetic card reader 157 is configured for use in scanning a customer's credit card, debit card or other magnetic strip carrying payment device. Other payment receiving devices such as coin or bill receivers may also be included.

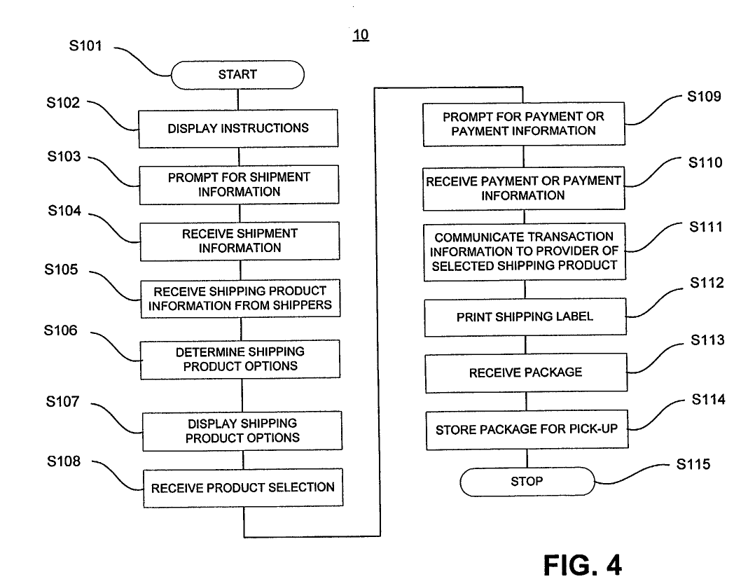

FIG. 4 presents a flow diagram of a shipping transaction method 10 that can be used in conjunction with the shipping system 100. The method 10 starts at step S101. At step S102, instructions for initiating a transaction using the shipping system 100 are displayed for a customer by the GUI 122. The instruction display may be commanded by the data input and validation module 132 in response to a cue that a customer is present. This cue may be provided by the customer by, for example, touching any key on a keyboard or by touching anywhere on a touch screen. An instruction for providing the initial cue may be displayed by the GUI 122 or on a hard copy sign somewhere in or around the ordering station 120. Complete instructions for the use of the system 100 may also be displayed in hard copy form.

At step S103, the GUI 122 prompts the customer for information regarding the customer's shipment. This step may be accomplished through a series of interactive questions that can be answered by the customer using the input device of the GUI 122 or through the use of one or more on-screen forms that can be filled out using the input device. At step S104, the shipment information entered by the customer is received by the data input and validation module 132. The information may be temporarily stored in the transaction data backup module 136 for use in assembling shipping product options and for assembling a transaction record. The shipment information preferably includes sender name, address and phone number, recipient name, address and phone number and customer preferences with respect to certain aspects of the shipment. The shipment information may also include physical characteristics of the item being shipped such as type (e.g., envelope, carton, etc.), dimensions and weight. As noted above, a scale or measuring arrangement may be provided in the ordering station 110 to assist the customer in obtaining weight and dimension information.

Aspects for which a customer may be asked to express a preference or provide additional information may include but are not limited to the mode of transport to be used (e.g., ground or air), whether a signature should be required upon receipt, the nature of the destination (e.g., home or business), a specific delivery date and/or time, a price range and whether insurance is to be requested and if so the value for which the item is to be insured.

At step S105, the data processor 124 receives shipping product information from one or more shippers A, B, C via the network 180. Such information may be obtained during the interaction between the system 100 and a particular customer or may be obtained prior to the transaction and stored in the shipper interface module 137 or other portion of the data processor 124. The shipping product information as received from each shipper A, B, C may include cost information as a function of destination, timing and shipment characteristics for a plurality of shipping products. The cost calculation module 133 and shipping option construction module 134 use the shipping product information along with the shipment information obtained from the customer to determine a plurality of product options at step S106. These options are displayed for the customer on the GUI 122 at step S107. At step S108, a product selection is communicated by the customer to the transaction completion module using the GUI 122.

At step S109, the customer may be prompted to provide payment or supply payment information for the selected shipping product. Depending on the ordering station configuration, the customer may be supplied with several payment options. These options may include payment using an established account with either the selected shipper or the business entity that maintains and operates the shipping system 100. Under this option, the customer is prompted to provide sufficient information to establish that the transaction should be billed to a particular account. Other payment options may include payment using a credit or debit card using a magnetic strip card reader 157. Cash may also be an option if the ordering station is operated in a semi-attended mode or if the ordering station includes a coin or bill receiving device.

When the customer service site 110 is a location such as a convenience store or other outlet having an attendant or cashier, payment for the shipping service may be made to the attendant or cashier. In such cases, payment may be made using the above-described methods as well as by cash or check. In this scenario, step S109 can be modified to include over-the-counter payment as one option, or step S109 can be eliminated so that all payments are accomplished with attendant or cashier assistance.

At step S110, payment or payment information is received by the transaction completion module 139. It will be understood that, depending on the configuration of the shipping system being used, step S110 may be carried out exclusively by the automated ordering station 120 or may be carried out at least in part by a human attendant or cashier. When payment is made to an attendant or cashier, step S110 may be carried out after the shipping label is printed at step S112.

At step S111, information relating to the transaction is transmitted to the ordering and tracking system of the selected shipper by the shipper interface module 137 via the network 180. This information alerts the shipper that there is a package to be picked up at the customer service site where the transaction is conducted. The transaction information includes all information ordinarily required by the shipper to process and track the package. This may include any or all of the information supplied by the customer along with time and location information. Depending on the shipper, tracking information may be returned to the data processor 124 from the shipper's system via the network. This information may then be used on the shipping label, the customer's receipt or both. Such information may also be stored for later use in assembling a manifest for pick-up personnel. The transaction information may also be transmitted to the SQL server 190.

If information from the shipper is not required to print the shipping label or complete the transaction, the step of transmitting transaction information need not be carried out contemporaneously with the transaction. The transaction information may be temporarily stored in the data processor 124 for later transmission. In some embodiments, information from multiple transactions may be assembled for transmission to the appropriate shippers. Such transmissions may be done on a regular periodic basis or upon completion of a predetermined number of transactions.

At step S112, a shipping label is printed for application to the package. A receipt for the customer may also be printed. The configuration of the shipping label and the information included thereon may vary depending on the requirements of the selected shipper. The shipping label may automatically be printed and dispensed to the customer who can then apply the label to the package or present the label and the package to an attendant or cashier. Alternatively, the shipping label may be selectively printed by the attendant or cashier who can apply it to the package or present it to the customer for application. Once the label is placed on the package, the labeled package may be placed in a storage location for pick-up at step S114. The method ends at step S115.

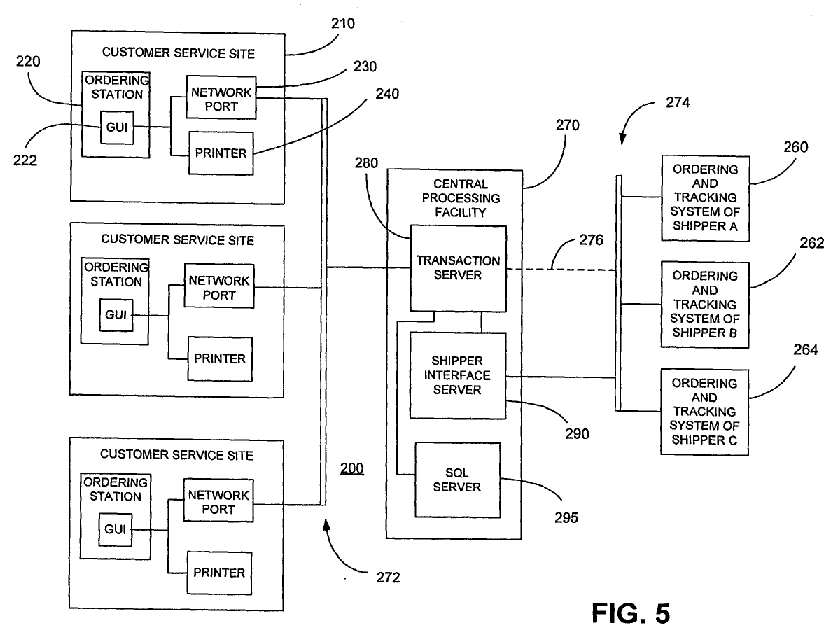

FIG. 5 is a schematic representation of a shipping system 200 according to the invention. The shipping system 200 includes a plurality of ordering stations 220, each located at a different customer service site 210. Possible customer service sites 210 may include, for example, convenience stores, mailing service outlets and shopping malls. The shipping system 200 also includes a central processing facility 270 that uses a first network 272 to communicate information to and from the ordering stations 220. As will be discussed in more detail hereafter, in this system, data processing associated with shipping transactions at the various ordering stations 220 is performed at the central processing facility 270, rather than at the ordering stations 220. This significantly reduces the processing capability required at the customer service sites 210. The central processing facility 270 is selectively connected to a second network (which may be the same as the first network) through which the central processing facility may communicate with the ordering and tracking systems 260, 262, 264 of a plurality of shippers A, B, C.

Each ordering station 220 includes a graphical user interface (GUI) 222 that is connected to a network port 230 to allow selective communication of information to and from the GUI 222 via the first network 272. Connection to the first network 272 allows the GUI 222 to be used to communicate information to and from the central processing facility 270.

The GUI 222 preferably includes means for displaying a series of graphical images that assist in conducting a shipping transaction with a customer. These images are configured to lead the customer through a step-by-step process for purchasing a shipping product. The GUI 222 includes one or more input devices such as a touch-screen or keyboard for use by the customer in providing information to the shipping system 200. The ordering station 220 may also include a scale for weighing packages and/or an arrangement for measuring package dimensions. The scale and measuring arrangement may be configured to automatically provide weight and size information to the system 200. Alternatively, the scale and measuring arrangement may be configured to provide information to the customer who can then enter the information using the input device of the GUI 222.

The central processing facility 270 is preferably a secure data facility that includes a transaction server 280, a shipper interface server 290 and an SQL server 295. The transaction server 280 is configured to communicate with the system components of the various customer service sites 210 for conducting shipping transactions with customers at these sites 210. The transaction server 280 uses information provided by the customers and shipping product information stored in the shipper interface server 290 to construct shipping product options for the customers. Finalized transaction information assembled by the transaction server 280 is transmitted to the ordering and tracking systems 260, 262, 264 of the various shippers A,B,C.

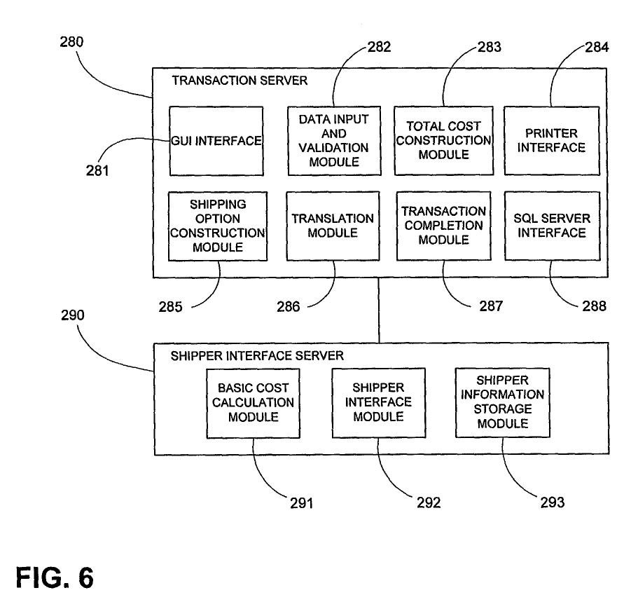

The transaction server 280 and shipper interface server 290 are shown in more detail in FIG. 6. The transaction server 280 may include a GUI interface 281, a data and input validation module 282, a total cost construction module 283, a printer interface 284, a shipping option construction module 285, a translation module 286, a transaction completion module 287 and an SQL server interface. The shipper interface server 290 may include a basic cost calculation module 291, a shipper interface module 292 and a shipper information storage module 293.

Although the system 200 is shown with a single shipper interface server 290, it will be understood by those having ordinary skill in the art that multiple servers 290 may also be used without departing from the spirit and scope of the invention. In particular, it may be advantageous to have a separate shipper interface server 290 for each shipper A, B, C.

The GUI interface module 281 is used to send output to and receive input from the GUI 222 of each ordering station 220 via the first network 272. The data input and validation module 282 is configured and programmed to transmit prompts via the GUI interface module 281 for display to the customer. These prompts are used to elicit customer information required for conducting a shipping transaction. This information may include desired shipping destination and arrival time, package characteristics, desired price range and individual customer information. The prompts are displayed to the customer using the GUI 222. The data input and validation module 282 is further configured to receive responses to these prompts entered by the customer using the GUI 222.

The data input and validation module 282 is adapted to review the various customer data entries to assure their validity. Among other things, the data input and validation module 282 may be used to assure that valid zip code, telephone, street address and e-mail address information is entered. The data input and validation module 282 may also be used to assess whether all required data fields are populated and all required selections made. Other customer information may also be verified. The data input and validation module 282 may be configured to assign a transaction reference number to the data associated with a particular transaction.

The total cost construction module 283 uses shipping product cost information along with the information provided by the customer to determine the total cost of various shipping options. The cost information is then sent to the shipping option construction module 285, which uses the total cost information to construct a menu of shipping product options. This menu is then displayed for the customer using the GUI 222. The total cost construction module 283 uses information provided by the basic cost calculation module 291 of the shipper interface server 290. As will be discussed in more detail hereafter, the basic cost calculation module 291 uses cost formulae and/or tables provided by the shippers to calculate the basic shipping cost associated with a particular shipping product. The total cost construction module 283 takes the basic cost information for a given shipping product and adds additional amounts for add-on services requested by the customer and, if desired, a premium for use of the shipping system. Add-on services may include, for example, Saturday delivery, signature delivery, rural delivery, etc.

Upon receiving a set of customer-provided item information and shipping criteria, the total cost construction module determines the shipping products that might meet the shipping criteria and requests basic cost information from the cost calculation module 291. The cost calculation module 291 includes software for calculating cost based on shipping origin and destination zip codes. This software uses look-up tables or formulas provided by the various shippers to determine costs for various options. The shipper-provided information is preferably received from the shippers at predetermined intervals and stored in a shipper information storage module 293 of the shipper interface server.

In an exemplary cost determination scenario, a shipper's cost structure may be based on discrete distance ranges (zones). Different cost formulae or tables are used for each zone. The zone for a given transaction may be determined by the basic cost calculation module 291 using longitude and latitude values for the origin and destination zip codes. The formulae or tables for that zone may then be used to establish rates for the given package size and weight and various service options that meet the customer's shipping criteria. The basic cost information for the various shipping options are passed back to the cost construction module, which then adds any additional costs as necessary.

These are then sent to the shipping construction module 285 for use in constructing the shipping product option menu. The shipping product option menu may be limited to only those options meeting the criteria entered by the customer or may include other options that are close to meeting such criteria.

Upon display of the shipping option menu, the shipping option construction module 285 prompts the customer to make a selection from the displayed options. The transaction completion module 287 is configured and programmed to receive an option selection from the GUI 222. The transaction completion module 287 assembles a set of transaction information which includes customer information, information relating to the item to be shipped and information for the selected shipping product. The transaction information preferably also includes the transaction reference number.

In some embodiments, the transaction completion module 287 may also be adapted for requesting payment from the customer. In such embodiments, payment is preferably made by providing credit or debit account information to the transaction server 280 using the GUI 222. The transaction completion module 287 may be adapted for validating the payment information provided by the customer. In addition or in the alternative, the ordering station 220 may be equipped with cash accepting devices such as coin or bill receivers. In such embodiments, the transaction completion module 287 may be configured to verify that the proper amount has been deposited before proceeding with a transaction.

The transaction completion module 287 provides the assembled transaction information to the translation module 286. The translation module 286 provides an interface between the transaction completion module 287 of the transaction server 280 and the shipper interface module 292 of the shipper interface server 290. The translation module 286 provides the transaction information to the shipper interface module 292 in the proper format for the selected shipper and assures that the transaction information includes a master account number if required by the shipper. The master account number is an account number assigned by the shipper to the proprietor of the shipping system 200. Use of the master account number assures that the shipping system proprietor—not the customer—is billed by the shipper.

The transaction completion module 287 may also transmit the transaction information to the SQL server 195 for storage therein. The SQL server 195 may be adapted for permanent storage of transaction information and for using the transaction information to assemble customer invoices and billing information.

The shipper interface server 290 is adapted for selective communication with the purchasing and tracking systems 260, 262, 264 of the shippers A, B, C via the second network 274. The shipper interface module 292 includes interface software to complete shipping orders with the purchase and tracking software of the shippers. The interface software is specifically adapted to be compatible with the shippers' systems and may be provided by the shippers themselves.

The shipper interface module 292 communicates transaction information to the purchasing and tracking system of the shipper selected by the customer. In some embodiments, the shipper interface module 292 may receive in return, information for use by the printer interface 284 in printing a shipping label for the item to be shipped or for providing to the customer for his use in tracking the package. The transaction information provided by the shipper interface module 284 may include the selected shipper, the type of shipping product selected (transportation mode, destination, arrival time, etc.), size and weight of the item, location of the ordering station and customer information. Information returned by the shipper to the shipper interface module 292 may vary depending on the shipper. The shipper interface module 292 may be configured to receive tracking information for the package from the purchasing and tracking system of the selected shipper. This tracking information may then be passed to the transaction server 280, which, in turn may pass the information to the SQL server 295 where it can be stored with the other transaction information. The tracking information may also be transmitted to the ordering station 220 for display on the GUI 222 or for printing a shipping label and/or receipt using a printer 240 at the customer service site 210.

In many instances, it is preferable that a transaction not require interaction with the selected shipper's system during the transaction. Accordingly, the system 200 may be configured so that transaction information for multiple transactions is stored for batch submission to the appropriate shippers. The transaction information may be stored either in the transaction server 280 or the shipper interface server 290. This approach provides a significant advantage to the customer in that shipping transactions may be conducted even if the shippers' systems are temporarily inaccessible.

The first and second networks 280, 290 may each be any distributed network, such as a local area network (LAN), a wide area network (WAN), Internet, Ethernet, etc. The network may include wired and/or wireless components to enable access to and communication among the various system components. In a preferred embodiment, the communications server 230 includes an arrangement for satellite access to the first network. It will be understood that in some embodiments, the first and second network may be the same network.

Significantly, the various aspects of the shipping system 200, and in particular, the ordering station 220, may be adapted so that the customer perceives no substantial operational difference between the shipping system 200 and the shipping system 100 of FIG. 1. High speed data transmission between the ordering station 220 and the central processing facility 270 makes it so there is no significant delay in response to data input or menu selections entered on the GUI 222. The ordering station 220 itself may be substantially similar to the ordering station 120 of the shipping system 100 with the exception of the fact that it may not include a data processor 120. Aside from the data processor 120, the features of the kiosk 150 shown in FIG. 3 are equally applicable to an ordering station 220 of the shipping system 200. Graphics and screen directions displayed by the GUI may also be the same for both systems.

Each customer service site 210 may have one or more printers 240 in communication with the central processing facility 270 via the network port 230 and the first network 272. The printer or printers 240 may be used for printing shipping labels, receipts and manifest information. The transaction server 280 includes a printer interface 284 which may be use to send commands to the printer or printers 240 via the first network 272.

In some embodiments, a printer 240 may be incorporated into the ordering station 220 itself. In such embodiments, the printer 240 can be used to provide a shipping label directly to a customer upon verification of payment or account information. In other embodiments, such as those located inside a retail outlet, a printer 240 may be physically separated from the ordering station 220 so as to be accessible to an attendant or cashier. In these embodiments, the printer 240 can be used to print labels for application by the attendant or for the attendant to relay to the customer upon payment.

At least one printer 240 at each customer service site 210 is preferably accessible by shipping service pickup personnel for use in printing manifest information. This allows pickup personnel on regular schedules to print a list of the items (if any) to be picked up from that customer service site 210. This list can then be used to assure that all such items are indeed taken into the shipper's possession.

The shipping system 200 may be used in conjunction with the shipping transaction method 10 of FIG. 4 and may be used in both a fully automated mode and in a semi-attended mode. The following paragraphs describe the method 10 as carried out by the shipping system 200.

As before, the method begins at step S101. At step S102, instructions for initiating a transaction using the shipping system 200 are displayed for a customer by the GUI 222, preferably in response to a cue that a customer is present. This cue may be provided by the customer by, for example, touching any key on a keyboard or by touching anywhere on a touch screen. An instruction for providing the initial cue may be displayed by the GUI 222 or on a hard copy sign somewhere in or around the ordering station 220. Complete instructions for the use of the system 200 may also be displayed in hard copy form.

At step S103, the data input and validation module 282 commands the GUI 222 to prompt the customer for information regarding the customer's shipment. This step may be accomplished through a series of interactive questions that can be answered by the customer using the input device of the GUI 222 or through the use of one or more on-screen forms that can be filled out using the input device. The shipment information entered by the customer is transmitted to the secure central processing facility 270 where it is used by the transaction server 280 to assemble shipping product options and for assembling a transaction record. The shipment information preferably includes sender name, address and phone number, recipient name, address and phone number and customer preferences with respect to certain aspects of the shipment. The shipment information may also include physical characteristics of the item being shipped such as type (e.g., envelope, carton, etc.), dimensions and weight. As noted above, a scale or measuring arrangement may be provided in the ordering station 210 to assist the customer in obtaining weight and dimension information.

As before, the customer may be asked to express a preference or provide additional information with respect to certain aspects of the desired shipping product. This may include but is not limited to the mode of transport to be used (e.g., ground or air), whether a signature should be required upon receipt, the nature of the destination (e.g., home or business), a specific delivery date and/or time, a price range and whether insurance is to be requested and if so the value for which the item is to be insured.

At step S105, the shipper interface server 290 receives shipping product information from one or more of the plurality of shippers A, B, C via the second network 274. Such information may be obtained during the interaction between the system 200 and a particular customer or may be obtained prior to the transaction and stored in the shipper information storage module 293 for later access. Shipping product information is preferably provided through regular periodic communication between the shipper interface server 290 and the shippers' purchasing and tracking systems 260, 262, 264. The shipping product information as received from each shipper A, B, C may include cost information as a function of destination, timing and shipment characteristics for a plurality of shipping products.

The cost construction module 283 of the transaction server 280 in cooperation with the basic cost calculation module 291 of the shipper interface server 290 uses the shipping product information along with the shipment information obtained from the customer to determine cost information for a plurality of product options. A menu of these options is constructed by the shipping option construction module at step S106. The menu of shipping options is transmitted to and displayed for the customer on the GUI 222 at step S107. At step S108, a product selection is communicated to the transaction completion module 287 by the customer using the GUI 222.

At step S109, the customer is prompted to provide payment or supply payment information for the selected shipping product. The payment options available to the customer are the same as in the method 10 in conjunction with the shipping system 100. At step S110, payment or payment information is received. As before, step S110 may be carried out exclusively by the automated ordering station 220 or may be carried out at least in part by a human attendant or cashier. When payment is made to an attendant or cashier, step S110 may be carried out after the shipping label is printed at step S112.

At step S111, information relating to the transaction is transmitted to the ordering and tracking system of the selected shipper. The transaction server 280 may provide the transaction information to the shipper interface server 290 which, in turn, may transmit the information to the shipper's system via the second network 274. In alternative embodiments, the transaction server 280 may be selectively connected to the second network via an optional network connection 276 so that the transaction server 280 may communicate the transaction information to the selected shipper. The transaction information alerts the shipper that there is a package to be picked up at the customer service site where the transaction was conducted. Depending on the shipper, tracking information may be returned to the shipper interface server 290 from the shipper's system via the network 274. The tracking information is communicated to the transaction server 280, which may then use the tracking information to assemble a shipping label and/or receipt file. Tracking information may also be stored at the central processing facility 270 for later use in assembling a manifest for pick-up personnel.

As noted above, in some embodiments, transaction information need not be transmitted to the shipper during the transaction. In such embodiments, step S111 may be conducted in a batch mode wherein information for a plurality of transactions is periodically assembled and transmitted to the appropriate shippers.

The shipping label and/or receipt file is transmitted to the printer 240 for printing at step S112. The configuration of the shipping label and the information included thereon may vary depending on the requirements of the selected shipper. The shipping label may automatically be printed and dispensed to the customer who can then apply the label to the package or present the label and the package to an attendant or cashier. Alternatively, the shipping label may be selectively printed by the attendant or cashier who can apply it to the package or present it to the customer for application. Once the label is placed on the package, the labeled package may be placed in a storage location for pick-up at step S114. The method ends at step S115.

The shipping systems 100, 200 are substantially identical from the viewpoint of the shippers' pick-up personnel. The GUI of either system may be used by pick-up personnel to request the printing of a manifest, which can then be used to verify that all of the correct items are picked up by the correct shipper.

Other embodiments and uses of the invention will be apparent to those skilled in the art from consideration of the specification and practice of the invention disclosed herein. The specification and examples should be considered exemplary only. The scope of the invention is limited only by the claims appended hereto.

What is claimed is:

1. A system for conducting shipping transactions, the system comprising:
a plurality of ordering stations, each ordering station having a user interface with a display device and at least one input device;
a data processing system in communication with the display device and the at least one input device, the data processing system being adapted for selective connection to a first network, for displaying information using the graphical display device, for receiving information from the input device and for selective communication with at least one shipper ordering and tracking system via the first network,
wherein a first portion of the data processing system is adapted for processing shipping preference information and item information received from a customer during a shipping transaction, for constructing a menu of shipping product options, for displaying the menu to the customer using the display device and for receiving a shipping product selection from the customer, and
wherein a second portion of the data processing system is adapted for use in communicating transaction information to any of the at least one shipper ordering and tracking system and for use in receiving shipping product information and tracking information from any of the at least one shipper ordering and tracking system.

2. A system according to claim 1 wherein the data processing system comprises a plurality of data processors, each data processor corresponding to and being co-located with a respective one of the plurality of ordering stations, each data processor being operatively connected to the user interface of its corresponding ordering station and being adapted for selective communication with the at least one shipper ordering and tracking system via the first network.

3. A system according to claim 2 wherein each data processor includes
a data input and validation module for processing shipping preference information and item information received from a customer during a shipping transaction;
a cost calculation module for determining costs of shipping product options;
a shipping option construction module for constructing a menu of shipping product options configured for display to the customer using the display device;
a transaction completion module for receiving a shipping product selection from the customer and for assembling transaction information; and
a shipper interface module adapted for communicating transaction information to any of the at least one shipper ordering and tracking system via the first network.

4. A system according to claim 3 wherein the shipper interface module is further adapted for receiving product information and tracking information from any of the at least one shipper ordering and tracking system via the first network.

5. A system according to claim 1 wherein the system further includes a central processing facility and the data processing system includes a transaction server and a shipper interface server located within the central processing facility, the transaction server being adapted for selective communication with the user interface of each ordering station via a second network, the shipper interface server being in communication with the transaction server and being adapted for selective communication with the at least one shipper ordering and tracking system via the first network.

6. A system according to claim 5 wherein the transaction server includes
a data input and validation module for processing shipping preference information and item information received from a customer during a shipping transaction;
a total cost calculation module for determining costs of shipping product options;
a shipping option construction module for constructing a menu of shipping product options configured for display to the customer using the display device; and
a transaction completion module for receiving a shipping product selection from the customer and for assembling transaction information.

7. A system according to claim 6 wherein the shipper interface server includes a shipper interface module adapted for communicating transaction information to any of the at least one shipper ordering and tracking system via the first network.

8. A system according to claim 7 wherein the shipper interface module is also adapted for receiving shipping product cost information from any of the at least one shipper ordering and tracking system via the first network and wherein the shipper interface server includes a shipper information storage module for storage of shipping product cost information therein.

9. A system according to claim 7 wherein the shipper interface module includes a basic cost calculation module adapted to automatically calculate a basic cost of each of the shipping product options using the item information, the preference information and the shipping product cost information.

10. A system according to claim 5 wherein the transaction server is adapted for conducting substantially simultaneous shipping transactions with two or more of the plurality of ordering stations.

11. A system according to claim 1 wherein the menu of shipping product options comprises the shipping product information of a plurality of shipping products meeting a set of criteria constructed from the preference information and the item information.

12. A system according to claim 11 wherein the plurality of shipping products includes shipping products from more than one shipper.

13. A system according to claim 1 wherein each ordering station includes a scale in communication with the data processing system, the scale being adapted for receiving and weighing an item to be shipped and the data processing system being adapted for receiving weight information from the scale for use in constructing the menu of shipping product options.

14. A system according to claim 1 wherein the data processing system is adapted to display a payment option menu using the display device and for receiving a payment option selection from the at least one input device.

15. A system according to claim 1 wherein the data processing system is configured for receiving account information relating to one or both of a credit account and a debit account.

16. A system according to claim 15 wherein each ordering station includes a magnetic card reader in communication with the data processing system, the magnetic card reader being adapted for reading customer account information from a magnetic strip on a customer's credit or debit card.

17. A system according to claim 1 wherein each ordering station includes a printer in communication with the data processing system, the printer being configured for printing a shipping label for application to an item to be shipped.

18. A system for conducting shipping transactions, the system comprising a plurality of ordering stations, each ordering station having a data processor, a user interface having a display device and at least one input device in communication with the data processor, a network port in communication with the data processor and a network, wherein each data processor includes:
a data input and validation module for processing shipping preference information and item information received from a customer during a shipping transaction;
a cost calculation module for determining costs of shipping product options;
a shipping option construction module for constructing a menu of shipping product options configured for display to the customer using the display device;
a transaction completion module for receiving a shipping product selection from the customer and for assembling transaction information; and
a shipper interface module adapted for communicating transaction information to any of the at least one shipper ordering and tracking system via the network.

19. A system according to claim 18 wherein the shipper interface module is further adapted for receiving shipping product information and tracking information from any of the at least one shipper ordering and tracking system via the network.

20. A system according to claim 19 wherein the menu of shipping product options comprises the shipping product information of a plurality of products meeting a set of criteria constructed from the preference information and the item information.

21. A system according to claim 20 wherein the plurality of products includes shipping products from more than one shipper.

22. A system according to claim 20 wherein the cost calculation module is adapted to automatically calculate the cost of each of the plurality of products using the item information, the preference information and the shipping product information.

23. A system according to claim 18 wherein the item information includes a weight of the item.

24. A system according to claim 18 wherein each ordering station includes a scale in communication with the data processing system, the scale being adapted for receiving and weighing an item to be shipped and the data processing system being adapted for receiving weight information from the scale for use in calculating product option costs.

25. A system according to claim 18 wherein the transaction completion module is adapted to display a payment option menu using the display device and for receiving a payment option selection from the at least one input device.

26. A system according to claim 18 wherein the transaction completion module is configured for receiving account information relating to one or both of a credit account and a debit account.

27. A system according to claim 26 wherein each ordering station includes a card reader in communication with the data processing system, the card reader being adapted for reading customer account information from a customer's credit or debit card.

28. A system according to claim 18 wherein each ordering station includes a printer in communication with the data processing system, the printer being configured for printing a shipping label for application to an item to be shipped.

29. A system according to claim 18 further comprising an SQL server in communication with the network, the data processor being adapted for selective communication with the SQL server for transmission of transaction information thereto.

30. A system for conducting shipping transactions, the system comprising:
a plurality of ordering stations, each ordering station having a user interface with a display device and at least one input device, the user interface being in communication with a network port in selective communication with a first network;
a transaction server in communication with the first network, the transaction server being adapted for selective communication with the user interface of each ordering station via the first network, the transaction server including:
a data input and validation module for processing shipping preference information and item information received from a customer during a shipping transaction,
a total cost calculation module for determining costs of shipping product options,
a shipping option construction module for constructing a menu of shipping product options configured for display to the customer using the display device, and
a transaction completion module for receiving a shipping product selection from the customer and for assembling transaction information;
a shipper interface server in communication with the transaction server and being adapted for selective communication with a plurality of shipper ordering and tracking systems via a second network, the shipper interface server including a shipper interface module adapted for communicating transaction information to any of the at least one shipper ordering and tracking system via the first network.

31. A system according to claim 30 wherein the shipper interface module is also adapted for receiving shipping product cost information from any of the at least one shipper ordering and tracking system via the first network and wherein the shipper interface server includes a shipper information storage module for storage of shipping product cost information therein.

32. A system according to claim 31 wherein the shipper interface module includes a basic cost calculation module adapted to automatically calculate a basic cost of each of the plurality of products using the item information, the preference information and the shipping product cost information.

33. A system according to claim 32 wherein the menu of shipping product options comprises shipping product information for a plurality of products meeting a set of criteria constructed from the preference information and the item information.

34. A system according to claim 33 wherein the plurality of products includes shipping products from more than one shipper.

35. A system according to claim 33 wherein the basic cost calculation module is adapted to automatically calculate a basic cost of each of the plurality of products using the item information, the preference information and the shipping product cost information.

36. A system according to claim 30 wherein the transaction server is adapted for conducting substantially simultaneous shipping transactions with two or more of the plurality of ordering stations.

37. A system according to claim 30 wherein the item information includes a weight of the item.

38. A system according to claim 30 wherein each ordering station includes a scale in communication with the data processing system, the scale being adapted for receiving and weighing an item to be shipped and the data processing system being adapted for receiving weight information from the scale for use in constructing the menu of shipping product options.

39. A system according to claim 30 wherein the transaction completion module is adapted to display a payment option menu using the display device and for receiving a payment option selection from the at least one input device.

40. A system according to claim 30 wherein the transaction completion module is configured for receiving account information relating to one or both of a credit account and a debit account.

41. A system according to claim 40 wherein each ordering station includes a card reader in communication with the data processing system, the card reader being adapted for reading customer account information from a customer's credit or debit card.

42. A system according to claim 30 wherein each ordering station includes a printer in communication with the data processing system, the printer being configured for printing a shipping label for application to an item to be shipped.

43. An ordering station for a shipping transaction system having a data processing system, the ordering station comprising:
a kiosk structure having a support platform, and cabinet walls defining a cabinet interior space;
a display device disposed on the support platform and being in selective communication with the data processing system via a network, the display device being adapted for displaying instructions and information transmitted to the display device by the data processing system via the network during a shipping transaction;
at least one user input device in selective communication with the data processing system via the network, the at least one input device being adapted for receiving shipment information and transmitting the shipment information to the data processing system via the network during a shipping transaction; and
a printer disposed in the cabinet interior space, the printer being in selective communication with the network and being adapted for receiving shipping label information from the data processing system and for printing a shipping label for application to an item to be shipped.

44. An ordering station according to claim 43 wherein the ordering station is disposed at a location remote from the data processing system.

45. An ordering station according to claim 43 wherein the ordering station includes means for accepting payment for a shipping transaction, the means for accepting payment being in communication with the data processing system via the network.

46. A method of conducting a shipping transaction using a shipping transaction system having a data processing system in selective communication with at least one shipper purchasing and tracking system, the method comprising:
providing an ordering station having a user interface with a graphic display device and at least one input device, the user interface being in communication with the data processing system;
receiving shipment information into the data processing system, the shipment information including customer shipping preferences and characteristics of an item to be shipped, at least a portion of the shipment information having been entered into the shipping transaction system by a customer using the at least one input device;
receiving shipping product information into the data processing system from the at least one shipper purchasing and tracking system;
determining a set of shipping product options using the shipment information and the shipping product information;
displaying the set of shipping product options to the customer using the graphic display device;
receiving a shipping product selection from the customer using the at least one input device; and
receiving the item to be shipped into a storage area for later pick-up.

47. A method according to claim 46 wherein each ordering station includes a printer in communication with the data processing system, the method further comprising:
printing a shipping label for application to the item being shipped.

48. A method according to claim 46 further comprising the steps of:
displaying a payment prompt using the graphic display device; and
receiving payment information from the customer using the at least one input device.

49. A method according to claim 46 further comprising the steps of:
displaying a payment prompt using the graphic display device; and
receiving payment from the customer.

50. A method according to claim 46 further comprising the step of communicating a set of transaction information to a selected one of the at least one shipper purchasing and tracking system, the set of transaction information including at least a portion of the shipment information.

51. A method according to claim 46 wherein the set of shipping product options includes shipping product information for shipping products from two or more shippers.

52. A method according to claim 46 wherein the step of providing an ordering station includes providing a data processor in communication with the user interface, the data processor being adapted for selective communication with the at least one shipper ordering and tracking system via a network and wherein the steps of receiving shipping product information and determining a set of shipping product options are carried out by the data processor.

53. A method according to claim 46 wherein the data processing system includes a transaction server in communication with the user interface and a shipper interface server in communication with the at least one shipper ordering and tracking systems, the transaction server and the shipper interface server being disposed in a central processing facility remote from the ordering station, and wherein the step of receiving shipping product information is carried out by the shipper interface server and the step of determining a set of shipping product options is carried out by the transaction server.

54. A method according to claim 46 further comprising the step of:
calculating a cost for each shipping product option using the shipment information and the shipping product information.
